(19) United States
(12) Patent Application Publication
(10) Pub. No.: US 2024/0067183 A1
(43) Pub. Date: Feb. 29, 2024

(54) SYSTEM AND METHOD FOR DETERMINING AN ADAPTABILITY OF A DRIVER AND A DRIVING DIFFICULTY OF A VEHICLE

(71) Applicant: Bendix Commercial Vehicle Systems LLC, Avon, OH (US)

(72) Inventor: Andreas U. Kuehnle, Strängnäs (SE)

(73) Assignee: Bendix Commercial Vehicle Systems LLC, Avon, OH (US)

(21) Appl. No.: 17/894,657

(22) Filed: Aug. 24, 2022

(51) Int. Cl. B60W 40/09; B60W 50/08; G07C 5/08

(52) U.S. Cl. CPC B60W 40/09; B60W 50/085; G07C 5/0808

(57) ABSTRACT

The present disclosure is directed systems and methods that determine an adaptability of a driver and a driving difficulty of a vehicle. In one form, a processor of a driver adaptability system receives driver performance information from a first vehicle and records a first plurality of driver events associated with the performance of the first driver while driving the first vehicle. The processor further receives driver performance information from a second vehicle and records a second plurality of driver events associated with the performing of the first driver while driving the second vehicle. The processor determines a level of adaptability of the first driver based on at least a difference in performance of the first driver in the first plurality of driver events and the second plurality of driver events.

### BACKGROUND

A performance of a driver while operating a vehicle can depend on an experience level of the driver, the ability of the driver to adapt and learn, as well factors such a level of traffic, a route the driver is driving, or weather. When a driver is confronted with new situations, novel routes, or a different vehicle, the driver needs to adapt. Whether in commercial or consumer settings, it would be desirable to know an ability of a driver to adapt to new situations and a level of driving difficulty associated with driving particular vehicles. With this information, commercial fleet systems would be able to pair drivers with a high ability to adapt to challenging vehicles and/or routes, for example, or vehicles with a high driving difficulty level may have their operations automatically adjusted when a driver does not have a high ability to adapt.

### SUMMARY OF THE DISCLOSURE

The present disclosure describes implementations of system and methods that determine an adaptability of a driver and a driving difficulty of a vehicle, and adjust an operation of a vehicle based on the determined adaptability of the driver and driving difficulty of the vehicle.

In one aspect, the present disclosure includes a system that comprises a memory and at least one processor configured to execute instructions stored in the memory. The at least one processor is further configured to receive driver performance information from at least one of a controller, a sensor, or another system of a second vehicle; to evaluate a performance of a first driver while driving the second vehicle over a second time period based on the received driver performance information; and to record a second plurality of driver events over time associated with the performance of the first driver while driving the second vehicle, wherein the second time period occurs after a first time period during which the first driver drives a first vehicle.

The at least one processor is further configured to determine a level of adaptability of the first driver based on a change in performance of the first driver in the second plurality of driver events, and based on the level of adaptability of the first driver, to perform at least one of alert the first driver to the level of adaptability of the first driver with respect to a third vehicle that the first driver is operating or alter one or more performance operations of the third vehicle that the first driver is operating based on the level of adaptability of the first driver.

In another aspect, the present disclosure includes a method in which at least one processor receives driver performance information from at least one of a controller, a sensor, or another system of a second vehicle. Further, the at least one processor evaluates a performance of a first driver while driving the second vehicle over a second time period based on the received driver performance information and records a second plurality of driver events over time associated with the performance of the first driver while driving the second vehicle, wherein the second time period occurs after a first time period during which the first driver drives a first vehicle.

The at least one processor additionally determines a level of adaptability of the first driver based on a change in performance of the first driver in a? second plurality of driver events, and based on the level of adaptability of the first driver, performs at least one of alerting the first driver to the level of adaptability of the first driver with respect to a third vehicle that the first driver is operating or altering one or more performance operations of the third vehicle that the first driver is operating based on the level of adaptability of the first driver.

### BRIEF DESCRIPTION OF THE DRAWINGS

FIG. 1 is a graph illustrating a performance of a driver while operating a first vehicle and a performance of the driver while operating a second vehicle versus time.

FIG. 2 is a schematic block diagram illustrating an environment in which one form of a driver adaptability monitoring system may operate.

FIG. 3 is a flow chart of one form of a method for determining an adaptability of a driver and altering an operation of a vehicle based on the adaptability of the driver

FIG. 4 is a flow chart of one form of a method for determining a prediction of a performance of a driver when operating a vehicle based on determined adaptability of drivers and determined driving difficulty of vehicles.

### DETAILED DESCRIPTION OF THE DRAWINGS

The present disclosure describes implementations of systems and methods that determine an adaptability of a driver and a driving difficulty of a vehicle. When a driver is confronted with new situations, novel routes, or a different vehicle, the driver needs to adapt. Whether in commercial or consumer settings, having information on an ability of a driver to adapt to new situations and a level of driving difficulty associated with various vehicles provides the ability to increase driving safety by matching drivers with specific a vehicle, or even adjusting an operation of a vehicle, based on an ability of a driver to adapt and a driving difficulty of a vehicle.

As discussed in more detail below, a system may evaluate and measure an adaptability of a driver by monitoring driver performance information that a vehicle generates while the driver operates the vehicle, and comparing the driver performance information against driver performance information that the same driver generates when operating other vehicles or driver performance information that other drivers generate when operating the same vehicles. In some implementations, the driver performance information may include information such as a speed of a vehicle, an acceleration of the vehicle, a lane departure warning of the vehicle, a forward collision warning of the vehicle, a specific driver action associated with the first vehicle such as quick steering wheel changes, a video from a perspective of the vehicle, or a rate of driver related events that a driver generates while operating the vehicle.

Typically, when a driver operates a new vehicle, actions of the driver will normally generate more vehicle warnings while operating the new vehicle for a period of time until the driver adapts to the new vehicle. For example, actions of the driver may generate more lane departure warnings per mile or excessive curve speed events while driving the new vehicle than the same driver generated while operating a previous vehicle.

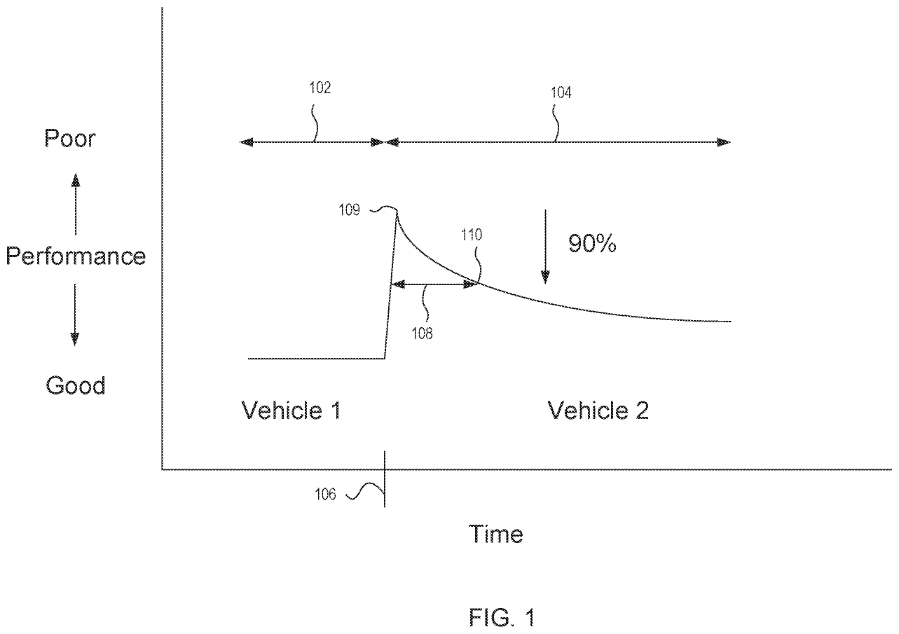

FIG. 1 is a graph illustrating a performance of a driver while operating a first vehicle 102 and a performance of the driver while operating a second vehicle 104. As illustrated, when a driver changes from the first vehicle to the second vehicle at point 106, the performance of the driver quickly decreases. However, the performance of the driver while operating the second vehicle increases over time (that is, the rate of driver events decreases) as the driver adapts to the second vehicle 104.

In some implementations, an adaptability of a driver may be measured as, after changing vehicles, how long it takes for a performance of a driver operating a new vehicle to decrease from an initial maximum bad performance of the driver (a worst performance) to within a defined percentage of a steady state performance of the driver while operating the new vehicle. In some implementations, a steady state performance of the driver while operating a vehicle may occur when a number of driving events per unit of time at a number of sequential points in time within a time period does not change by more than a defined amount.

Continuing with the example illustrated in FIG. 1, an adaptability of the driver may be measured as adaptation time 108. The adaptation time 108 may be how long it takes the performance of the driver while operating the second vehicle 104 to decrease 90% (110) from an initial maximum bad performance 109 of the driver to a steady state while operating the second vehicle 104. In this example, performance of the driver may be measured as a number of driver performance events per unit of time, where the driver performance events may be events such as lane departure warnings, excessive speed or acceleration warnings, or braking warnings that occur while the driver operates a vehicle. In some implementations, the adaptation time 108 for a longitudinal control of the vehicle and lateral control of the vehicle may be determined separately.

In some implementations, a driver monitoring system may generate a mathematical model to fit a change in performance of the driver over time. Using the mathematical model of the change in performance, a decay constant may be inferred, which is used to represent an adaptation time constant of the driver. For the decay constant, a shorter decay constant, representing a shorter adaptation time constant for the driver, is considered a better driving performance than a longer decay constant, representing a longer adaptation time constant for the driver.

A driver adaptability monitoring system may be configured to collect and record data over a period of time, miles, trips, or any other unit of measurement. The data can include driver and/or vehicle related data collected from components of, or components interacting with, the driver adaptability monitoring system. The components may include one or more driver facing imaging sensors, such as cameras, configured such that a field of view of the imaging sensor captures an image of a driver of the vehicle, as well as other areas of a vehicle cabin, such as the driver controls of the vehicle while driving and non-driver passenger areas. Other imaging sensors may be configured to capture other scenes relative to the vehicle, including but not limited to scenes in front of the vehicle, behind the vehicle, to either side of the vehicle, etc.

The components may further include vehicle devices, sensors and/or systems configured to provide non-video data, including non-video data corresponding to driver and/or vehicle related events. Such components may include one or more microphones, independent or in connection with the imaging sensors, configured to capture audio recordings of areas of the cabin and/or other vehicle areas (e.g., engine noise, etc.).

Examples of events that may be detected and/or collected by the monitoring system include but are not limited to: safety events, for example and without limitation, excessive acceleration, excessive braking, exceeding speed limit, excessive curve speed, excessive lane departure, lane change without turn signal, loss of video tracking, LDW system warning, following distance (i.e., headway) alert, forward collision warning, collision mitigation braking, collision occurrence, etc., and non-safety events, for example and without limitation, the driver logging in/out of a vehicle telematics system, the driver/passenger entering/leaving the vehicle, the driver/passenger occupying/vacating the bunk area, the driver occupying/vacating the driver seat, the vehicle engine being on/off, the vehicle gear being in park/drive, the parking brake being on/off, etc.

The driver adaptability monitoring system may use event data collected directly from vehicle devices, sensors, and/or systems, which may include data collected from an analysis of vehicle video, to generate datasets that correspond in time with one or more detected events. Data generated for a detected event may be associated with captured video frames whose timeline spans or overlaps the time when the event was detected/collected. Event data generated from an event determined from processing of captured vehicle video may at least be associated with the video from which it was generated, but may also be associated with other captured video frames whose timelines span or overlap the time when the event was detected/collected (in these scenarios, the time may be calculated based on the video frame or frames from which the event object was derived).

The driver adaptability monitoring system may be further configured to collect and provide performance-based data corresponding to detected performance indicators characterizing driving performance. The performance-based data can include vehicle and/or driver related data collected from components of, or components interacting with, the monitoring system, including but not limited to vehicle devices, sensors and/or systems. The monitoring system may also use the performance-based data to detect performance events, as a particular type of driver and/or vehicle related event, and to generate associated datasets that correspond in time with one or more detected events.

Accordingly, the components, individually and collectively, may be configured to detect, in real time, the performance indicators (and/or performance events), and/or to report such performance indicators (and/or performance events) to the monitoring system. Examples of performance indicators include but are not limited to: following distance (i.e., headway), driving smoothness, driver hand positioning (e.g., gestures), driver head position, fatigue metrics, vigilance and reaction time measurements, etc., and any other indicator tending to characterize driving performance—particularly with respect to potentially impaired and/or enhanced driving performance due to, for example, distraction, inattention, increased focus, co-piloting, or other behavior.

The driver adaptability monitoring system may further be configured to control one or more vehicle systems in response to detected events. Examples of such control include but are not limited to: providing one or more types of warnings (e.g., driver assistance system warnings, warnings to passengers in the cabin that the driver requires assistance, etc.), intervening in the operation of the vehicle (e.g., to initiate corrective action, to activate harm mitigating features, to assume autonomous control, etc.), setting driver/passenger authorizations for the driving excursion (e.g., via vehicle telematics, etc.), and alerting remote locations/devices (e.g., backend servers, dispatch center computers, mobile devices, etc.) of such events. A variety of corrective actions may be possible and multiple corrective actions may be initiated at the same time.

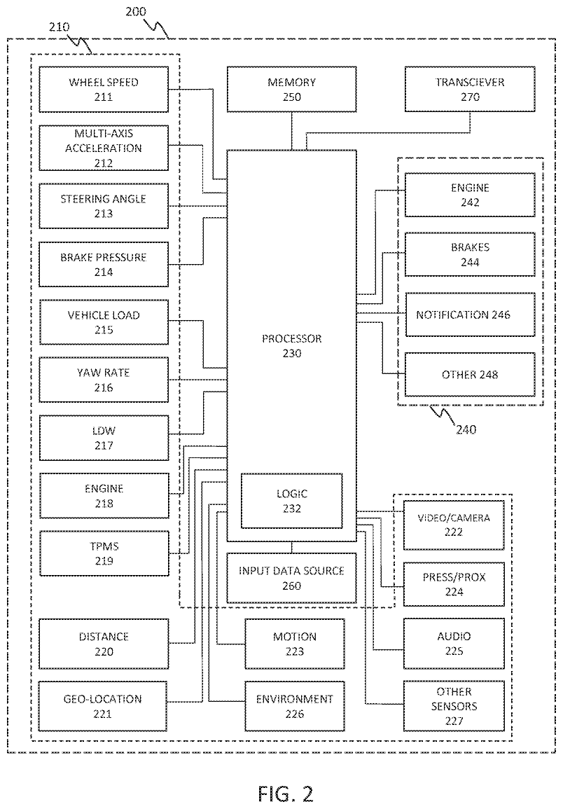

FIG. 2 is a schematic block diagram illustrating an environment in which one form of a driver adaptability monitoring system may operate. The driver adaptability monitoring system 200 is configured to detect a variety of operational parameters and conditions of the vehicle and the driver's interaction therewith (i.e., event-based data, performance-based data, etc.).

The driver adaptability monitoring system 200 may include one or more devices or systems 210 for providing vehicle and/or driver related data, including data indicative of one or more operating parameters or one or more conditions of a commercial vehicle, its surroundings and/or its cabin occupants. The driver adaptability monitoring system 200 may, alternatively or additionally, include a signal interface for receiving signals from the one or more devices or systems 214, which may be configured separate from system 200. For example, the devices 210 may be one or more sensors, such as but not limited to, one or more wheel speed sensors 211, one or more acceleration sensors such as multi-axis acceleration sensors 212, a steering angle sensor 213, a brake pressure sensor 214, one or more vehicle load sensors 215, a yaw rate sensor 216, a lane departure warning (LDW) sensor or system 217, one or more engine speed or condition sensors 218, and a tire pressure (TPMS) monitoring system 219. The driver adaptability monitoring system 200 may also utilize additional devices or sensors, including for example a forward distance sensor and/or a rear distance sensor 220 (e.g., radar, lidar, etc.) and/or a geo-location sensor 221. Additional sensors for capturing driver related data may include one or more imaging devices 222, such as cameras or video sensors, and/or motion sensors 223, pressure or proximity sensors 224 located in one or more seats and/or driver controls (e.g., steering wheel, pedals, etc.), audio sensors 225, or other sensors configured to capture driver related data. The driver adaptability monitoring system 200 may also utilize environmental sensors 226 for detecting circumstances related to the environment of the driving excursion, including for example, weather, road conditions, time of day, traffic conditions, etc. Other sensors 227, actuators and/or devices or combinations thereof may be used or otherwise provided as well, and one or more devices or sensors may be combined into a single unit as may be necessary and/or desired. For example, biometric sensors may be included for detecting biometric data of the vehicle occupants.

The driver adaptability monitoring system 200 may also include a logic applying arrangement such as a controller or processor 230 and control logic 232, in communication with the one or more devices or systems. The processor 230 may include one or more inputs for receiving data from the devices or systems. The processor 230 may be adapted to process the data and compare the raw or processed data to one or more stored threshold values or desired averages or value ranges, or to process the data and compare the raw or processed data to one or more circumstance-dependent desired values, so as to detect one or more driver and/or vehicle related events.

The processor 230 may also include one or more outputs for delivering a control signal to one or more vehicle control systems 240 based on a determined adaptability of a driver of the vehicle, detection of other events, and/or in response to vehicle and/or driver related data. The control signal may instruct the systems 240 to provide one or more types of driver assistance warnings (e.g., warnings relating to braking, obstacle avoidance, driver performance, passenger performance, etc.) and/or to intervene in the operation of the vehicle to initiate corrective action. For example, the processor 230 may generate and send the control signal to an engine electronic control unit 242 or an actuating device to reduce the engine throttle and slow the vehicle down. Further, the processor 230 may send the control signal to one or more vehicle brake systems 244 to selectively engage the brakes (e.g., a differential braking operation). Warnings may be given at different time points to help the driver adapt to the new vehicle more quickly. A variety of corrective actions may be possible and multiple corrective actions may be initiated at the same time.

The vehicle control components may further include brake light(s) and other notification devices 246, which may be configured to provide warnings and/or notifications externally to the vehicle surroundings and/or internally to the vehicle occupants. Example warnings and/or notifications include: headway time/safe following distance warnings, lane departure warnings, warnings relating to braking and or obstacle avoidance events, warnings related to driver performance, warnings related to passenger performance, and any other type of warning or notification in furtherance of the embodiments described herein. Other vehicle control systems 248 may also be controlled in response to detected events and/or event data.

The driver adaptability monitoring system 200 may also include a memory portion 250 for storing and accessing system information, such as for example the system control logic 232. The memory portion 250, however, may be separate from the processor 230. The sensors 210, controls 240 and/or processor 230 may be part of a preexisting system or use components of a preexisting system.

The driver adaptability monitoring system 200 may also include a source of vehicle-related input data 260, which may be indicative of a configuration/condition of the commercial vehicle and/or its environmental circumstances (e.g., road conditions, geographic area conditions, etc.). The processor 230 may sense or estimate the configuration/condition and/or environmental circumstances of the vehicle based on the input data, and may select a control tuning mode or sensitivity based on the vehicle configuration/condition and/or environmental circumstances. The processor 230 may compare the operational data received from the sensors 210 to the information provided by the tuning. Such tuning may be useful, for example, where a distracting passenger is present while driving a heavily loaded vehicle. Such input data may be further useful in evaluating driving performance, as described herein. For example, the driving performance of one or more driving team may be evaluated with respect to common environmental circumstances (e.g., performance in less desirable geographic areas).

In addition, the driver adaptability monitoring system 200 is operatively coupled with one or more driver facing imaging devices, shown for simplicity and ease of illustration as a single driver facing camera 222 that is trained on the driver and/or trained on the interior of the cab of the commercial vehicle. However, it should be appreciated that one or more physical video cameras may be disposed on the vehicle such as, for example, a video camera on each corner of the vehicle, one or more cameras mounted remotely and in operative communication with the driver adaptability monitoring system 200 such as a forward facing camera 222 to record images of the roadway ahead of the vehicle. Such cameras may, for instance, indicate undesirable proximity to objects, the roadway verge, etc.

In some implementations, driver related data is collected directly using the driver facing camera 222, such driver related data including head position, eye gaze, hand position, postural attitude and location, or the like, within the vehicle. In addition, driver identity and/or presence can be determined based on facial recognition technology, body/posture template matching, and/or any other technology or methodology for making such determinations by analyzing video data.

In operation, the driver facing camera 222 generates video data of the captured image area. The video data may be captured on a continuous basis, or in response to a detected event. Such data may comprise a sequence of video frames with separate but associated sensor data that has been collected from one or more on-vehicle sensors or devices, as detailed herein.

The driver adaptability monitoring system 200 may also include a transmitter/receiver (transceiver) module 270 such as, for example, a radio frequency (RF) transmitter including one or more antennas for wireless communication of data and control signals, including control requests, event-based data, performance-based data, vehicle configuration/condition data, or the like, between the vehicle and one or more remote locations/devices, such as, for example, backend servers, dispatch center computers, and mobile devices, having a corresponding receiver and antenna. The transmitter/receiver (transceiver) module 270 may include various functional parts of sub portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 230 may be operative to select and combine signals from the sensor systems into driver related data and/or event-based data and/or performance-based data representative of higher-level vehicle data. For example, data from the multi-axis acceleration sensors 212 may be combined with the data from the steering angle sensor 213 to determine excessive curve speed event data. Other hybrid data relatable to the vehicle and/or driver and obtainable from combining one or more selected raw data items from the sensors includes, for example and without limitation, excessive braking event data, excessive curve speed event data, lane departure warning event data, excessive lane departure event data, lane change without turn signal event data, lane change without mirror usage data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, following distance event data, fuel consumption event data, ACC usage event data, and late speed adaptation (such as that given by signage or exiting). Still other hybrid data relatable to the vehicle and/or driver and obtainable from combining one or more selected raw data items from the sensors includes, for example and without limitation, driver out of position event data, passenger out of position event data, driver distracted event data, driver drowsy event data, driver hand(s) not on wheel event data, passenger detected event data, wrong driver event data, seatbelt not fastened event data, driver cellphone use event data, distracting passenger event data, mirror non-use event data, unsatisfactory equipment use event, driver smoking event data, passenger smoking event data, insufficient event response event data, insufficient forward attention event data. The aforementioned events are illustrative of the wide range of events that can be monitored for and detected by the driver adaptability monitoring system 200, and should not be understood as limiting in any way.

The driver adaptability monitoring system 200 may further include a bus or other communication mechanism for communicating information, coupled with the processor 230 for processing information. The system may also include a main memory 250, such as random access memory (RAM) or other dynamic storage device for storing instructions and/or loaded portions of a trained neural network to be executed by the processor 230, as well as a read only memory (ROM) or other static storage device for storing other static information and instructions for the processor 230. Other storage devices may also suitably be provided for storing information and instructions as necessary or desired.

In some implementations, the driver adaptability monitoring system 200 of FIG. 2 is configured to execute one or more software systems or modules that perform or otherwise cause the performance of one or more features and aspects described herein. Computer executable instructions may therefore be read into the main memory 250 from another computer-readable medium, such as another storage device, or via the transceiver 270. Execution of the instructions contained in main memory 250 may cause the processor 230 to perform one or more of the process steps described herein. In some implementations, hard-wired circuitry may be used in place of or in combination with software instructions to implement the disclosure. Thus, implementations of the example embodiments are not limited to any specific combination of hardware circuitry and software.

Methods for determining an adaptability of a driver and a driving difficulty of a vehicle, such as those described below, may be performed within the environment described above in conjunction with FIG. 2.

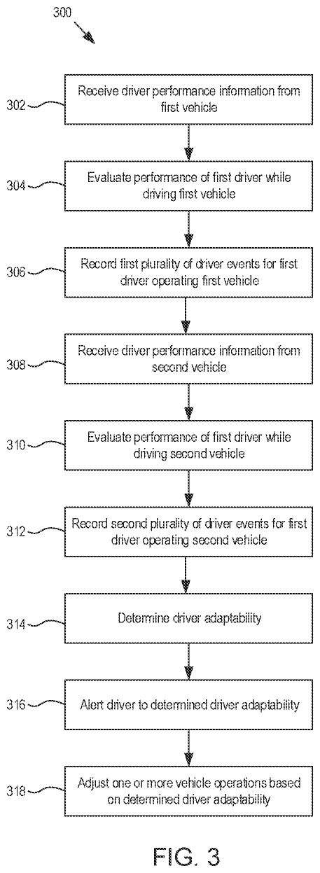

FIG. 3 is a flow chart of one form of a method 300 for determining an adaptability of a driver and altering one or more operations of a vehicle based on the adaptability of the driver.

At step 302, a processor of a driver monitoring system, such as those described above in conjunction with FIG. 2, receive driver performance information from at least one of a controller, a sensor, or a system of a first vehicle. In some implementations, part or all of the driver monitoring system may be integrated with a vehicle, integrated with a mobile device of a driver, such as a smartphone or tablet, and/or be integrated with a server that is external to the vehicle, such as a server of a fleet operations system.

In some implementations, the driver performance information received at the driving monitoring may include at least one of a speed of the first vehicle, an acceleration of the first vehicle, a lane departure warning of the first vehicle, a forward collision warning of the vehicle, a driver action associated with the first vehicle, a video from a perspective of the first vehicle, or a rate of driver related events that occur while operating the vehicle.

At step 304, the processor evaluates a performance of a first driver while driving the first vehicle over a first time period based on the received driver performance information. In some implementations, the processor evaluates the performance of the first driver while driving the first vehicle by determining an amount of time between different rates at which driving events caused by actions of the driver occur within the first time period, such as amount of time between an initial maximum difference in performance to within a defined percentage of or variation about a steady state performance; determining an overall change in a rate at which the driving events caused by actions of the driver occur at points of time within the first time period, such as a time of the initial maximum difference in performance and a time of the steady state performance; and/or by determining a number of driving events that occur over the first time period that are caused by actions of the driver. In some implementations, the processor may then compare these values to values of other drivers in order to determine a relative performance of the first driver as a good, quickly adaptable, driver or a bad, poorly adapting, driver.

In some implementations, a driver event of the first plurality of driver events comprises driver performance information of the first vehicle that includes at least one of a speed of the first vehicle, an acceleration of the first vehicle, a lane departure warning of the first vehicle, a forward collision warning of the vehicle, a driver action associated with the first vehicle, a video from a perspective of the first vehicle, or a rate of driver related events that the driver generates while operating the vehicle.

At step 306, the processor records in a memory a first plurality of driver events over time associated with the performance of the first driver while driving the first vehicle.

At step 308, the processor receives performance information from at least one of a controller, a sensor, or another system of a second vehicle. As discussed above, the driver performance information may include at least one of a speed of the second vehicle, an acceleration of the second vehicle, a lane departure warning of the second vehicle, a forward collision warning of the second vehicle, a driver action associated with the second vehicle, a video from a perspective of the second vehicle, or a rate of driver related events that the driver generates while operating the vehicle.

At step 310, the processor evaluates a performance of the first driver while driving the second vehicle over a second time period based on the received driver performance information. As discussed above, in some implementations, the processor evaluates the performance of the first driver while driving the second vehicle by determining an amount of time between different rates at which driving events caused by actions of the driver occur within the second time period, such as amount of time between an initial maximum difference in performance to a defined percentage of a steady state performance; determining an overall change in a rate at which the driving events caused by actions of the driver occur at points of time within the first time period, such as a time of the initial maximum difference in performance and a time of the steady state performance; and/or by determining a number of driving events that occur over the first time period that are caused by actions of the driver. In some implementations, the processor may then compare these values to values of other drivers in order to determine a relative performance of the first driver as a good driver or a bad driver.

In some implementations, a driver event of the second plurality of driver events comprises driver performance information of the second vehicle that include at least one of a speed of the second vehicle, an acceleration of the second vehicle, a lane departure warning of the second vehicle, a forward collision warning of the second vehicle, a driver action associated with the second vehicle, a video from a perspective of the second vehicle, or a rate of driver related events that a driver generates while operating the vehicle.

At step 312, the processor records in a memory a second plurality of driver events over time associated with the performance of the first driver while driving the second vehicle, where the first time period occurs before the second time period.

At step 314, the processor determines a level of adaptability of the first driver based on a change in performance of the first driver in the second plurality of driver events.

In some implementations, the processor determines the adaptability of the driver at step 314 by first determining, based on the second plurality of driver events, an initial maximum difference in performance of the first driver during the second time period.

The processor then determines, based on the second plurality of driver events, an amount of time for the performance of the first driver driving the second vehicle to decrease a defined amount from the initial maximum difference in performance to a steady state performance, also known as an adaptation time.

As discussed above in conjunction with FIG. 1, when a driver changes from the first vehicle to the second vehicle at point 106, the performance of the driver quickly decreases. However, the performance of the driver while operating the second vehicle increases over time as the driver adapts to the second vehicle.

In some implementations, the amount of time for the performance of the first driver driving the second vehicle to decrease a defined amount from the initial maximum difference in performance to a steady state performance may be measured in in linear time, such as a number of minutes, hours, days, or weeks. In other implementations, the amount of time for the performance of the first driver driving the second vehicle to decrease a defined amount from the initial maximum difference in performance to a steady state performance is measured in episodic time, such as a number of trips in a vehicle. In yet further implementations, the amount of time for the performance of the first driver driving the second vehicle to decrease a defined amount from the initial maximum difference in performance to a steady state performance is measured in spatial time, such as distance (a number of miles).

Referring again to FIG. 3, after determining the amount of time for the performance of the first driver driving the second vehicle to decrease a defined amount from the initial maximum difference in performance to a steady state performance, the processor may then set the level of adaptability of the first driver based on the determined amount of time.

In some implementations, the processor may set a level of adaptability of a driver such as good or poor adaptability in relation to determined levels of adaptability and driving performance of other drivers, where in other implementations, the processor may set a level of adaptability of a driver in relation to defined criteria.

In some implementations, an adaptation time for a longitudinal control of the vehicle and lateral control of the vehicle may be determined separately. In these implementations, the driver adaptability monitoring system may monitor and record driver events relating to lateral movement of a vehicle separate from driver events relating to longitudinal movement of the vehicle. Driver events relating to lateral movement of the vehicle may relate to performance issues with respect to steering of the vehicle, for example, and driver events relating to longitudinal movement of the vehicle may relate to performance issues with respect to braking of the vehicle, for example.

In some implementations, as part of setting a level of adaptability of the first driver, the processor may generate a mathematical model to fit a change in performance of the first driver over time as the first driver changes from the first vehicle to the second vehicle. Using the mathematical model of the change in performance, a decay constant may be inferred, which is used to represent an adaptation time constant of the first driver. For the decay constant, a shorter decay constant, representing a shorter adaptation time constant for the driver, is considered a better driving performance than a longer decay constant, representing a longer adaptation time constant for the driver.

In some implementations, least-squares modeling of exponential decay or optimization of parameters may be used to fit a mathematical model to driver performance and determine a decay constant. In one example, the processor may initially model performance P on a new vehicle as:

P=S+Q*exp(−a*time),

where S is a steady state performance, Q*exp (−a*time) is time varying decay, exp is a natural logarithm function, and a is an unknown constant that determines how quickly a driver adapts.

A large a means quick adaptation, and a small a means slow adaptation. A value for S may be obtained when deviations from S no longer exceed +/−10%, for example. Once S is determined, it may be removed from P to obtain the decay (adaptation) section only, (P−S)=Q*exp (−a*time).

A value for Q can be determined as a delta in performance level from the steady state (if measured as events per mile, then a higher value than those achieved later) reached at the beginning of the adaptation time, such as a first time a driver operates a new vehicle. However, in other implementations another occurrence such as a second or third that a driver operates the new vehicle could be used. That is, Q can be read from the data.

In an illustrative example, the processor analyzes performance data at times 0, 1, 2, and 3 with corresponding events per mile measured at 2.0, 0.72, 0.32 and 0.12, and generates a mathematical model to fit a change in performance with P=S+Q*exp (−a*time). A maximum event rate occurs at time=0, and therefor Q is therefore near 2.0. The processor calculates a natural logarithm (ln) of both sides of the equation to determine ln(P)=ln(Q)−a*time. Utilizing a value of P, a determined approximation for Q and the time values, the processor utilizes a least-squares solver to obtain Q=1.942 and a=0.925. Accordingly, when these values are compared with Q=2 and a=1, it will be appreciated that a least-squares fit is close to the original starting parameters, again with the value of a reflecting a driver's adaptability level.

At step 316, based on the level of adaptability of the first driver, the processor may alert the first driver to the level of adaptability of the first driver with respect to a vehicle the first driver has previously operated, such as the first and/or second vehicle discussed above, or alert the first driver to the level of adaptability of the first driver with respect to a vehicle that the first driver has not yet driven, such as a new third vehicle.

Additionally, at step 318, based on the level of adaptability of the first driver, the processor may alter one or more performance operations of a vehicle that the first driver is operating, whether it be a vehicle the first driver has previous driven, such as the first and/or second vehicle discussed above, or a new vehicle that the first driver is driving for the first time, such as a new third vehicle.

With respect to steps 316 and 318, for example, the processor may increase a level of warnings for the first driver while operating a third vehicle when it is determined that the driver has a low level of adaptability. In some implementations, this may include the processor displaying or emitting an alert to the driver. For example, the processor may alert a driver that other drivers with similar adaptability levels have had difficulties steering this specific vehicle and that warnings such as land departure warnings will be adjusted. In another example, the processor may alert a driver that, based on the determined adaptability level of the driver, the driver has had problems maintaining a safe follow distance between vehicles and that the processor may provide extra warnings with respect to forward vehicles.

The processors may display an alert on a vehicle display and/or a mobile device of the driver, and may emit an alert from a vehicle audio system and/or the mobile device of the driver. In some of these implementations, the in-vehicle system may recognize the presence of the mobile device of the driver, for example, from its Bluetooth emanations, and push a pairing request to it. The mobile device of the driver and an audio generation chip in the in-vehicle system might then be used to deliver audible messages rather than visual ones. A similar mechanism may be applied to a Bluetooth-equipped radio in the vehicle.

In another example, the processor may increase an automatic breaking distance of an automatic driver intervention system of the third vehicle while the first driver is operating the third vehicle. In some implementations, this may include increasing at least one of an amount of time before a braking action that vehicle systems alert the driver to an upcoming braking action or increasing a distance before initiation of a braking action that vehicle systems alert a driver to an upcoming braking action. Further, the processor may perform operations such as adjusting a content of information of information that vehicle system provides to the user; a type of information that vehicle system provides to the user; an intensity of information that vehicle systems provide to the user; or a frequency with which vehicle system provides information to the user.

With respect to operations of the vehicle, the processor may also perform operations such as adjusting a braking performance of the vehicle or adjusting a stability performance of the vehicle. Braking performance may be adjusted to begin earlier or more positively. Braking may be set to start once the driver has removed their foot from the gas pedal and an object is detected ahead at close range. That is, braking is anticipated and started earlier than in normal operation with a usual ‘driver must actively start to brake’ scenario. In some circumstances, the processor may further perform actions such as engaging autonomous control of the vehicle, or once stopped in a safe location, prohibiting the driver from further operating the vehicle.

In yet a further example, the processor may adjust a side collision warning distance of the third vehicle while the first driver is operating the third vehicle. In some implementations, the may include alerting the driver earlier to objects or vehicles that could potentially case side collisions.

It should be appreciated that as driver adaptability monitoring systems record driver events across a plurality of drivers operating a plurality of vehicles and calculate adaptability values for multiple drivers operating multiple vehicles, the driver adaptability monitoring systems will generate a data set that may be utilized to calculate a degree of driving difficulty associated with the vehicles.

In some implementations, as driver adaptability monitoring systems calculate adaptability values for multiple drivers operating multiple vehicles, the driver adaptability monitoring systems generates a matrix of values. In one example, the rows of the matrix correspond to drivers and the columns of the matrix correspond to vehicles. A driver performance value in a position of the matrix for a combination of a driver and a vehicle may be equal to a number of driver events per unit of time, such as a number of driving events per hour. However, the driver performance value in a position of a matrix may also be other values such as a number of driver events per mile.

Once the matrix is constructed, driver adaptability monitoring systems may deconstruct the matrix to determine a first vector with values corresponding to a driver's contribution to the driver performance value for each vehicle they have operated and a second vector corresponding to a contribution of a vehicle to the driver performance value for each driver that has operated the vehicle. One of skill in the art will appreciate that one method to deconstruct a matrix into two vectors is to use an iterative process where initial estimates are made for the vector values and the estimates are iteratively updated until the values of the two vectors result in a matrix that are within a defined value of the target matrix, also known as a search precision.

For example, one or more driver adaptability monitoring systems may monitor the performance of three drivers using four vehicles. Of the twelve possible combinations of driver and vehicles, the one or more driver adaptability monitoring systems may monitor a driver performance of ten of the twelve possible combinations, as shown below in Table 1. That is, not all drivers have necessarily driven all vehicles, but each driver has driven at least two vehicles and each vehicle has been driven by at least two drivers

TABLE 1
Matrix of Driver Performance Values

| | Vehicle 1 | Vehicle 2 | Vehicle 3 | Vehicle 4 |
|---|---|---|---|---|
| Driver A | — | 11.4090 | 10.7925 | 16.4889 |
| Driver B | 11.8759 | 16.4172 | 18.7172 | 25.0347 |
| Driver C | 21.4897 | 25.6715 | 31.6302 | — |

To deconstruct this matrix, a processor of the driver adaptability monitoring system may set an initial estimate for a driver vector to be [X X X] and set an initial estimate for the vehicle vector to be [X X X X]. In some implementations, processor may set the initial estimates for the driver vector and the vehicle vector as random numbers. In other implementations, the processor may set the initial estimates for the driver vector and the vehicle vector such that their product is an average value of the entries present in the matrix.

The processor of the driver adaptability monitoring system multiplies the two vectors and measure the values of a resulting matrix to the target matrix in Table 1 above. When the absolute values of the difference in values is more than a desired tolerance, or the sum of the squared differences in values is larger than a threshold, the estimate values of the vectors are adjusted and the process is repeated, as know by those of skill in the art.

Once the estimated values in the driver vector and the vehicle vector result in a matrix that is within the defined value of the target matrix, the processor of the driver adaptability monitoring system may utilize the values within the driver vector and the vehicle vector may to predict a driver performance when a specific driver operates a specific car. For example, if a driver vector includes a value of 2.00 for Driver A and includes a value of 4.25 for Vehicle 1, the processor may predict a driver performance for Driver A operating Vehicle 1 to be 2.00*4.25=8.50, representing 8.50 driver events per unit of time.

One of skill in the art will appreciate that while the above process is described with respect to driver performance across drivers and vehicles in general, the above process could be refined with greater granularity to account for driver events indicative of different types of system issues on a vehicle. For example, the driver adaptability monitoring system may monitor and record driver events relating to lateral movement of a vehicle separate from driver events relating to longitudinal movement of the vehicle. Driver events relating to lateral movement of the vehicle may relate to performance issues with respect to steering of the vehicle and driver events relating to longitudinal movement of the vehicle may relate to performance issues with respect to braking of the vehicle. When a driver performance matrix is deconstructed, the driver adaptability monitoring system may determine a driver vector with values for an amount that a driver contributed to driver performance values with respect to driver events relating to lateral movement of a vehicle and with respect to driver events relating to longitudinal movement of the vehicle, and determine a vehicle vector with values for an amount that a vehicle contributed to driver performance values with respect to driver events relating to lateral movement of the vehicle and with respect to driver events relating to longitudinal movement of the vehicle. The magnitude of the vector entries for the drivers and the vector entries for the vehicles correspond to the skill, or lack thereof, of the drivers and the difficulty, or ease of, controlling the vehicle. Drivers may thereby be ranked from skilled to less skilled and vehicles ranked for difficult to control to easy to control.

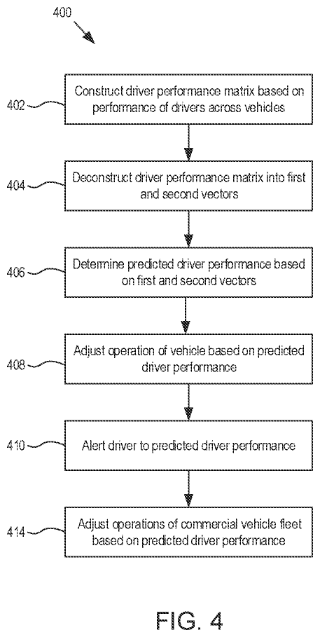

FIG. 4 is a flow chart of one form of a method 400 for determining a prediction of a performance of a driver when operating a vehicle based on determined adaptability of drivers and determined driving difficulty of vehicles.

At step 402 a processor of a driver adaptability monitoring system constructs a driver performance matrix based on a plurality of sets of driver events for a plurality of drivers operating a plurality of vehicles. In some implementations, the plurality of sets of driver events are recorded by a plurality of driver adaptability monitor systems utilizing the methods such as those described above in conjunction with FIG. 3.

At step 404, the processor of the driver adaptability monitoring system deconstructs the driver performance matrix into a first vector and a second vector. In some implementations, the first vector is a driver vector and the second vector is a vehicle vector. The driver vector represents for each driver of the plurality of drivers, their contribution to recorded driver performance values. The vehicle vector represents for each vehicle of the plurality of vehicles, its contribution to recorded driver performance values. However, in other implementations, the first and second vectors may represent vectors associated with driver performance values other that a driver vector and a vehicle vector.

At step 406, the processor of the driver adaptability monitoring system determines a predicted driver performance value for a first driver of the plurality of driver operating a first vehicle of the plurality of vehicles based on the first vector and the second value.

At step 408, the processor of the driver adaptability monitoring system adjusts an operation of the first vehicle based on the predicted performance value. In some implementations, this may include the processor may adjust driver assistance systems, as described above.

At step 410, the processor of the driver adaptability monitoring system alerts the first driver based on the predicted performance value, as described above.

At step 412, the processor of the driver adaptability monitoring system adjusts fleet operations of a commercial vehicle fleet based on the first and second vector. For example, in implementations where the first and second vectors represent driver and vehicle vectors, the processor may adjust fleet operations to assign adaptable drivers to vehicles with a high level of driving difficulty and/or assign adaptable drivers to routes that, based on information such as traffic, road conditions, and/or weather condition, are determined to be difficult routes. It will be appreciated that drivers that are determined to be highly adaptable regularly are likely determined to have high overall performance. Their adaptability reduces the initial transient period of increased driver event rates, and their high overall performance should produce a very good, safe, steady state performance after the adaptation period.

FIGS. 1-4 and their accompanying descriptions describe implementations of systems and methods for determining an adaptability of a driver and a driving difficulty of a vehicle, and adjusting the operations of a vehicle based on determined driver performance. Moreover, the described systems provide driver adaptability systems that are able to predict driver performance for specific drivers operating specific vehicles based on past driver performance across a plurality of drivers operating a plurality of vehicles.

Those having ordinary skill in the art may be able to make alterations and modifications to what is described herein without departing from its spirit and scope. The present disclosure is to be considered as an exemplification of the principles of the present disclosure, and is not intended to limit the broad aspects of the present disclosure to any embodiment or implementations described herein.

In accordance with the practices of persons skilled in the art, aspects of embodiments and implementations of the present disclosure may be described with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, code segments perform certain tasks described herein. The code segments can be stored in a processor readable medium. Examples of the processor readable mediums include an electronic circuit, a semiconductor memory device, a read-only memory (ROM), a flash memory or other non-volatile memory, a floppy diskette, a CD-ROM, an optical disk, a hard disk, etc.

In the detailed description and corresponding figures, numerous specific details are set forth in order to provide a thorough understanding of the present disclosure. However, it should be appreciated that the disclosure may be practiced without such specific details. Additionally, well-known methods, procedures, components, and circuits have not been described in detail.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner on one or more embodiments without limitation.

The term “server” means a functionally-related group of electrical components, such as a computer system that may or may not be connected to a network and which may include both hardware and software components, or alternatively only the software components that, when executed, carry out certain functions. The “server” may be further integrated with a database management system and one or more associated databases.

In accordance with the descriptions herein, the term “computer readable medium,” as used herein, refers to any non-transitory media that participates in providing instructions to the processor for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like.

In addition, and further in accordance with the descriptions herein, the term “logic,” as used herein, particularly with respect to FIG. 1, includes hardware, firmware, software in execution on a machine, and/or combinations of each to perform a function(s) or an action(s), and/or to cause a function or action from another logic, method, and/or system. Logic may include a software-controlled microprocessor, a discrete logic (e.g., ASIC), an analog circuit, a digital circuit, a programmed logic device, a memory device containing instructions, and so on. Logic may include one or more gates, combinations of gates, or other circuit components.

The embodiments and implementations described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1. A system comprising:
a memory; and
at least one processor configured to execute instructions stored in the memory and to:
receive driver performance information from at least one of a controller, a sensor, or another system of a second vehicle;
evaluate a performance of a first driver while driving the second vehicle over a second time period based on the received driver performance information and record a second plurality of driver events over time associated with the performance of the first driver while driving the second vehicle, wherein the second time period occurs after a first time period during which the first driver drives a first vehicle;
determine a level of adaptability of the first driver based on a change in performance of the first driver in the second plurality of driver events; and
based on the level of adaptability of the first driver, perform at least one of alert the first driver to the level of adaptability of the first driver with respect to a third vehicle that the first driver is operating or alter one or more performance operations of the third vehicle that the first driver is operating based on the level of adaptability of the first driver.

2. The system of claim 1, wherein to determine the level of adaptability of the first driver based on a change in performance of the first driver in the second plurality of driver events, the at least one processor is configured to:
determine, based on the second plurality of driver events, an initial maximum difference in performance of the first driver during the second time period;
determine, based on the second plurality of driver events, an amount of time for the performance of the first driver driving the second vehicle to decrease a defined amount from the initial maximum difference in performance to a steady state performance; and
set the level of adaptability of the first driver based on the determined amount of time for the performance of the first driver driving the second vehicle to decrease the defined amount from the initial maximum difference in performance to the steady state performance.

3. The system of claim 2, wherein the amount of time for the performance of the first driver driving the second vehicle to decrease the defined amount from the initial maximum difference in performance to the steady state performance is measured in linear time.

4. The system of claim 2, wherein the amount of time for the performance of the first driver driving the second vehicle to decrease the defined amount from the initial maximum difference in performance to the steady state performance is measured in episodic time.

5. The system of claim 2, wherein the amount of time for the performance of the first driver driving the second vehicle to decrease the defined amount from the initial maximum difference in performance to the steady state performance is measured in spatial time.

6. The system of claim 1, wherein the at least one processor is further configured to:
receive driver performance information from at least one of a controller, a sensor, or another system of the first vehicle; and
evaluate a performance of the first driver while driving the first vehicle over the first time period based on the received driver performance information and record a first plurality of driver events over time associated with the performance of the first driver while driving the first vehicle.

7. The system of claim 3, wherein the at least one processor is configured to:
determine a degree of driving difficulty of the first vehicle based on the first plurality of driver events associated with the performance of the first driver while driving the first vehicle and a third plurality of driver events associated with a performance of a second driver while driving the first vehicle; and
determine a degree of driving difficulty of the second vehicle based on the second plurality of driver events associated with the performance of the first driver while driving the second vehicle and a fourth plurality of driver events associated with a performance of the second driver while driving the second vehicle;
wherein the level of adaptability of the first driver is further based on the determined degree of driving difficulty of the first vehicle and the determined degree of driving difficulty of the second vehicle.

8. The system of claim 1, wherein to alter one or more performance operations of the third vehicle that the first driver is operating based on the level of adaptability of the first driver, the at least one processor is configured to at least one of:
increase a level of warnings for the first driver while operating the third vehicle;
increase an automatic braking distance of an automatic driver intervention system of the third vehicle while the first driver is operating the third vehicle; or
adjust a side collision or departure warning distance of the third vehicle while the first driver is operating the third vehicle.

9. The system of claim 1, wherein the memory and at least one processor are part of one or more servers that are external to the first and second vehicles.

10. The system of claim 1, wherein the memory and at least one processor are part of a mobile device of the first driver.

11. A method comprising:
receiving, with at least one processor, driver performance information from at least one of a controller, a sensor, or another system of a second vehicle;
evaluating, with the at least one processor, a performance of a first driver while driving the second vehicle over a second time period based on the received driver performance information and recording, with the at least one processor, a second plurality of driver events over time associated with the performance of the first driver while driving the second vehicle, wherein the second time period occurs after a first time period during which the first driver drives a first vehicle;
determining, with the at least one processor, a level of adaptability of the first driver based on a change in performance of the first driver in second plurality of driver events; and
based on the level of adaptability of the first driver, performing, with the at least one processor, at least one of alerting the first driver to the level of adaptability of the first driver with respect to a third vehicle that the first driver is operating or altering one or more performance operations of the third vehicle that the first driver is operating based on the level of adaptability of the first driver.

12. The method of claim 11, wherein determining the level of adaptability of the first driver based on a change in performance of the first driver in the second plurality of driver events, comprises:
determining, with the at least one processor, based on the second plurality of driver events, an initial maximum difference in performance of the first driver during the second time period;
determining, with the at least one processor, based on the second plurality of driver events, an amount of time for the performance of the first driver driving the second vehicle to decrease a defined amount from the initial maximum difference in performance to a steady state performance; and
setting, with the at least one processor, the level of adaptability of the first driver based on the determined amount of time for the performance of the first driver driving the second vehicle to decrease the defined amount from the initial maximum difference in performance to the steady state performance.

13. The method of claim 12, wherein the amount of time for the performance of the first driver driving the second vehicle to decrease the defined amount from the initial maximum difference in performance to the steady state performance is measured in linear time.

14. The method of claim 12, wherein the amount of time for the performance of the first driver driving the second vehicle to decrease the defined amount from the initial maximum difference in performance to the steady state performance is measured in episodic time.

15. The method of claim 12, wherein the amount of time for the performance of the first driver driving the second vehicle to decrease the defined amount from the initial maximum difference in performance to the steady state performance is measured in spatial time.

16. The method of claim 11, further comprising:
receiving, with the at least one processor, driver performance information from at least one of a controller, a sensor, or another system of the first vehicle;
evaluating, with the at least one processor, a performance of a first driver while driving the first vehicle over the first time period based on the received driver performance information and recording, with the at least one processor, a first plurality of driver events over time associated with the performance of the first driver while driving the first vehicle.

17. The method of claim 16, further comprising:
determining, with the at least one processor, a degree of driving difficulty of the first vehicle based on the first plurality of driver events associated with the performance of the first driver while driving the first vehicle and a third plurality of driver events associated with a performance of a second driver while driving the first vehicle; and
determining, with the at least one processor, a degree of driving difficulty of the second vehicle based on the second plurality of driver events associated with the performance of the first driver while driving the second vehicle and a fourth plurality of driver events associated with a performance of the second driver while driving the second vehicle;
wherein the level of adaptability of the first driver is further based on the determined degree of driving difficulty of the first vehicle and the determined degree of driving difficulty of the second vehicle.

18. The method of claim 17, wherein determining the degree of driving difficulty of the first vehicle comprises:
deconstructing, with the at least one processor, a matrix into a driver vector and a vehicle driving difficulty vector;
wherein one of rows or columns of the matrix correspond to a plurality of drivers and the other of rows or columns of the matrix correspond to a plurality of vehicles, and a value in the matrix for the first driver of the plurality of drivers and the first vehicle of the plurality of vehicles is approximately equal to a number of driver events per unit of time within the first plurality of driver events;

19. The method of claim 11, wherein altering one or more performance operations of the third vehicle that the first driver is operating based on the level of adaptability of the first driver comprises at least one of:
increasing a level of warnings for the first driver while operating the third vehicle;
increasing an automatic braking distance of an automatic driver intervention system of the third vehicle while the first driver is operating the third vehicle; or
adjusting a side collision or departure warning distance of the third vehicle while the first driver is operating the third vehicle.

20. The method of claim 11, wherein the at least one processor is part of one or more servers that are external to the first and second vehicles.

21. The method of claim 11, wherein the at least one processor is part of a mobile device of the first driver.
